(19) United States
(12) Patent Application Publication
(10) Pub. No.: US 2006/0187983 A1
(43) Pub. Date: Aug. 24, 2006

(54) Light emitting element driving circuit, and optical transmission apparatus and optical transmission system using the same

(75) Inventors: Tomo Baba, Kanagawa (JP); Shinya Kyozuka, Kanagawa (JP); Hisayoshi Mori, Kanagawa (JP); Kazuhiro Suzuki, Kanagawa (JP); Shinobu Ozeki, Kanagawa (JP); Takehiro Niitsu, Kanagawa (JP); Hidenori Yamada, Kanagawa (JP); Masao Funada, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/206,952

(22) Filed: Aug. 19, 2005

(30) Foreign Application Priority Data
Feb. 21, 2005 (JP) P.2005-044565

(51) Int. Cl. H01S 3/00

(52) U.S. Cl. 372/38.07; 372/38.1; 372/38.02

(57) ABSTRACT

A light emitting element driving circuit includes: plural AC-coupling capacitors which are connected together in series; and a bias generating circuit which generates a bias current, wherein a light emitting element is driven by superposing a modulating current to the bias current via the plural AC-coupling capacitors.

### BACKGROUND OF THE INVENTION

1. Field of the Invention

The present invention relates to a light emitting element driving circuit which drives a light emitting element such as a semiconductor laser by superposing a modulating current to a bias current, and an optical transmission apparatus, a laser printer, and a laser writing apparatus which use the light emitting element driving circuit.

2. Background Art

In an optical transmission system such as an optical LAN, for example, used is an optical transmission module which drives a semiconductor laser to emit a laser beam, and which superposes a modulating current to the semiconductor laser to produce a modulated beam.

As a light emitting element driving circuit used in an optical transmission module, for example, a circuit is known in which a semiconductor laser serving as a light emitting element is connected to a bias generating circuit, a predetermined bias current is supplied to the semiconductor laser, a modulated output of a differential circuit to which a modulating signal is input is applied to the semiconductor laser via an AC-coupling capacitor, and the semiconductor laser is driven by a combination of the bias current and the modulated output to obtain a modulated beam.

FIG. 2 shows a light emitting element driving circuit of the conventional art. The light emitting element driving circuit 100 uses a chip set of the product name “MAX3740A”, and is configured in accordance with the recommended circuit described in the data sheet.

The light emitting element driving circuit 100 includes: a laser driving IC 10 which drives a semiconductor laser 30; the semiconductor laser 30 in which the anode is connected to a bias output terminal 14 of the laser driving IC 10, and the cathode is grounded; ferrite beads 40 into which a wiring connecting the bias output terminal 14 and the anode of the semiconductor laser 30 is inserted; an AC-coupling capacitor 50 in which one end is connected to an output terminal 13a of the laser driving IC 10 outputting a plus-side modulating current; a resistor 60 which is connected between the AC-coupling capacitor 50 and the anode of the semiconductor laser 30; a capacitor 70 in which one end is connected to an output terminal 13b of the laser driving IC 10 outputting a minus-side modulating current; and a resistor 80 which is connected between the other end of the capacitor 70 and the ground.

The laser driving IC 10 uses the chip set MAX3740A, and includes: a pair of transistors 11a, 11b which form a differential circuit; a pair of input terminals 12a, 12b; the pair of output terminals 13a, 13b; the bias output terminal 14, resistors 15, 16 which are connected in series between the input terminals 12a, 12b; a resistor 17 which is connected between the junction between the resistors 15, 16, and a power source Vcc; a resistor 18 which is connected between the junction between the resistors 15, 16, and the ground; a resistor 19 through which the power source Vcc and the collector of the transistor 11a; a resistor 20 through which the power source Vcc and the collector of the transistor 11b; a constant current source 21 which is connected between the commonly connected emitters of the transistors 11a, 11b, and the ground; and a bias generating circuit 22.

The AC-coupling capacitor 50 connected to the output terminal 13a of the laser driving IC 10 is used for AC coupling, and combined with the resistor 60 to be selectively set to a capacitance at which a desired high-pass filter characteristic is obtained.

FIG. 3 shows the anode voltage-output characteristics of the semiconductor laser 30. In this case, the semiconductor laser 30 of an output wavelength of 850 nm is used. The bias output of the laser driving IC 10 is adjusted so that an average output of the semiconductor laser 30 is about 0.5 mW. As a result of the adjustment, a voltage of about 1.6 V is applied to the anode of the semiconductor laser 30.

The specification of the semiconductor laser 30 is set so that the upper limit of the output is 0.78 mW. In the circuit design, in the case of an apparatus specified as “Class 1” in which the laser output is lowest, it is important not to generate a laser beam exceeding the specified output level, from the viewpoint of laser safety. Therefore, the output of the semiconductor laser 30 must be adjusted so as not to exceed the above-mentioned value or 0.78 mW (2.1 V in terms of the voltage to be applied to the anode).

In FIG. 2, when no signal is input to the input terminals 12a, 12b, the semiconductor laser 30 is supplied with a constant current by the bias generating circuit 22 of the laser driving IC 10, and continuously generates a laser beam.

When a differential signal is then input as a modulating signal to the input terminals 12a, 12b, the transistors 11a, 11b operate as a differential amplifier, and output AC currents having a waveform according the differential signal, as modulated outputs +, − to the output terminals 13a, 13b.

The modulated output + which is output to the output terminal 13a is applied to the anode of the semiconductor laser 30 via the AC-coupling capacitor 50 and the resistor 60. In the semiconductor laser 30, the current of the semiconductor laser 30 is varied in accordance with the modulated output which is on the plus-side with respect to the bias current from the bias generating circuit 22, so that modulated light is generated by the semiconductor laser 30.

Also a semiconductor laser driving circuit is known which is configured so that, in contrast to the above-described configuration, the anode of a semiconductor laser is connected to a power source Vcc, the cathode is connected to a current source to ensure a bias current, and a modulating signal from a differential pair of transistors is supplied to the cathode via a capacitor (for example, see JP-T-2002-508116).

In the conventional light emitting element driving circuit, the output terminal 13a for the modulating current and the anode of the semiconductor laser 30 are connected to each other via the AC-coupling capacitor 50. When the AC-coupling capacitor 50 is short-circuited for some reason, therefore, the following situation occurs. Since the resistor 60 has a resistance as low as about 25Ω and the output terminal 13a the laser driving IC 10 is internally pulled up to Vcc (3.3 V), a voltage of about 2.1 V is applied to the anode of the semiconductor laser 30. Consequently, there is a possibility that the output exceeds the above-specified value of 0.78 mW and deviates the safety standard of “Class 1”.

In the configuration disclosed in JP-T-2002-508116, when the AC-coupling capacitor is short-circuited, the semiconductor laser is not affected, but an excessive current flows through the current source, thereby possibly causing the device to be disabled.

### SUMMARY OF THE INVENTION

Therefore, it is an object of the invention to provide a light emitting element driving circuit in which, even when an AC-coupling capacitor for superposing a modulating current to a bias current is short-circuited, abnormal light emission is prevented from occurring in a light emitting element, and peripheral devices can be protected, and also an optical transmission apparatus, a laser printer, and a laser writing apparatus which use the light emitting element driving circuit.

In order to attain the object, the invention provides a light emitting element driving circuit wherein the driving circuit drives a light emitting element by superposing a modulating current to a bias current via plural AC-coupling capacitors which are connected together in series.

According to the light emitting element driving circuit, even when one of the plural AC-coupling capacitors breaks to enter a short-circuit state, the AC coupling is maintained by the other AC-coupling capacitor(s).

As the light emitting element, useful is an LED, or a semiconductor laser such as a vertical-cavity surface-emitting laser.

The driving circuit can be applied to both a light emitting element in which a modulating current is supplied to the anode, and that in which a modulating current is supplied to the cathode.

The plural AC-coupling capacitors may be connected between an output terminal for the modulating current and the anode of the semiconductor laser. According to the configuration, even when one of the plural AC-coupling capacitors breaks to enter a short-circuit state, the AC coupling is maintained by the other AC-coupling capacitor(s). Therefore, an excessive current can be prevented from flowing through the semiconductor laser.

In order to attain the object, the invention provides an optical transmission apparatus wherein information is transmitted by a laser beam emitted from the vertical-cavity surface-emitting laser which is driven by the light emitting element driving circuit.

According to the optical transmission apparatus, even when one of the plural AC-coupling capacitors breaks to enter a short-circuit state, the AC coupling is maintained by the other AC-coupling capacitor(s). Therefore, the optical transmission can be stably conducted.

In order to attain the object, the invention provides a laser printer wherein a photosensitive member is exposed by a laser beam emitted from the vertical-cavity surface-emitting laser which is driven by the light emitting element driving circuit.

According to the laser printer, even when one of the plural AC-coupling capacitors breaks to enter a short-circuit state, the AC coupling is maintained by the other AC-coupling capacitor(s). Therefore, a stable printout can be obtained.

In order to attain the object, the invention provides a laser writing apparatus wherein a photosensitive member is exposed by a laser beam emitted from the vertical-cavity surface-emitting laser which is driven by the light emitting element driving circuit.

According to the laser writing apparatus, even when one of the plural AC-coupling capacitors breaks to enter a short-circuit state, the AC coupling is maintained by the other AC-coupling capacitor(s). Therefore, the writing operation can be stably conducted.

According to the invention, even when an AC-coupling capacitor for superposing a modulating current to a bias current is short-circuited, abnormal light emission is prevented from occurring in the light emitting element, and peripheral devices can be protected.

### BRIEF DESCRIPTION OF THE DRAWINGS

These and other objects and advantages of this invention will become more fully apparent from the following detailed description taken with the accompanying drawings in which:

FIG. 1 is a circuit diagram showing a light emitting element driving circuit of a embodiment of the invention;

FIG. 2 is a circuit diagram showing a light emitting element driving circuit of the conventional art;

FIG. 3 is a characteristic diagram showing the anode voltage-output characteristics of a semiconductor laser;

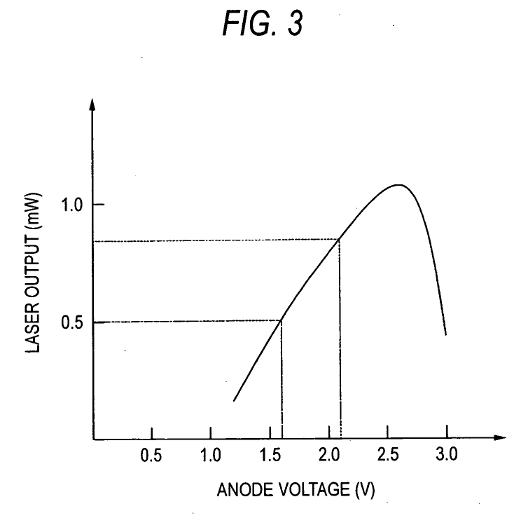

FIG. 4 is a block diagram showing an optical transmission system;

FIG. 5 shows an external view of an optical transmission apparatus;

FIGS. 6A and 6B are internal views of the optical transmission apparatus; FIG. 13A shows a top view of the internal structure; and FIG. 13B shows a side view of the internal structure;

FIG. 7 shows an image transmission system using the optical transmission apparatus of FIG. 5; and

FIG. 8 shows a rear view of the image transmission system of FIG. 7.

### DETAILED DESCRIPTION OF THE PREFERRED EMBODIMENTS

### First Embodiment

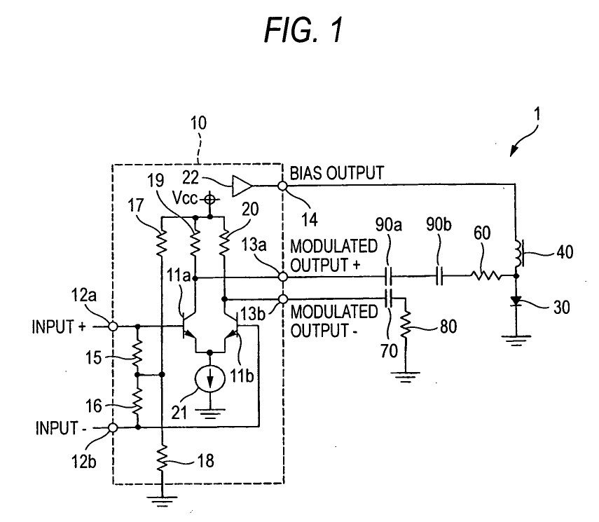

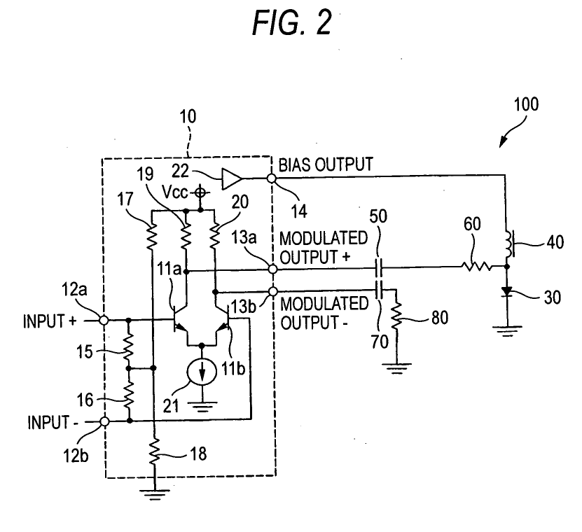

FIG. 1 shows a light emitting element driving circuit of a first embodiment of the invention. The light emitting element driving circuit 1 includes the laser driving IC 10, the semiconductor laser 30, the ferrite beads 40, the resistor 60, the capacitor 70, and the resistor 80 which have been described with reference to FIG. 2, and further includes two AC-coupling capacitors 90a, 90b which are connected together in series between the output terminal 13a and the anode of the semiconductor laser 30.

As described above, the laser driving IC 10 is configured in the same manner as the chip set MAX3740A, and includes a pair of transistors 11a, 11b, a pair of input terminals 12a, 12b, a pair of output terminals 13a, 13b, a bias output terminal 14, resistors 15, 16, 17, 18, 19, 20, a constant current source 21, and a bias generating circuit 22.

The bias generating circuit 22 can vary the voltage to be applied to the semiconductor laser 30 in the range of a bias voltage Vb>(Vcc-0.2) V, so that an optimum voltage can be set in accordance with the characteristics of the semiconductor laser 30. In the case of the semiconductor laser 30 producing an average output of about 0.5 mW, for example, the voltage to be applied to the anode can be set to 1.6 V.

As the semiconductor laser 30, a vertical-cavity surface-emitting laser (VCSEL) of an average output of about 0.5 mW is used. Alternatively, a semiconductor laser of a type other than the vertical-cavity surface-emitting laser may be used.

In order to make the combined capacitance of the AC-coupling capacitors 90a, 90b equal to the capacitance of the capacitor 50 in the conventional art, each of the capacitors 90a, 90b has, for example, a capacitance which is two times of that of the conventional capacitor 50. According to the configuration, a desired bypass filter can be configured in the same manner as the conventional art.

Operation of light emitting element driving circuit

In FIG. 1, when no signal is input to the input terminals 12a, 12b, the bias generating circuit 22 of the laser driving IC 10 applies a driving voltage of about 1.6 V to the semiconductor laser 30, and the semiconductor laser continuously emits a laser beam at an average output of about 0.5 mW.

When a differential signal is then input to the input terminals 12a, 12b, the transistors 11a, 11b operate as a differential amplifier, and output AC currents having a waveform according the differential signal, as modulated outputs +, − to the output terminals 13a, 13b.

The plus-side modulated output which is output to the output terminal 13a is applied to the anode of the semiconductor laser 30 via the AC-coupling capacitors 90a, 90b and the resistor 60. The minus-side modulated output which is output to the output terminal 13b is applied to the resistor 80 via the capacitor 70. In the semiconductor laser 30, the operation current of the semiconductor laser 30 is varied in accordance with the value of the modulated output which is on the plus-side with respect to the operation state of the bias generating circuit 22, so that modulated light is generated by the semiconductor laser 30.

If one of the AC-coupling capacitors 90a, 90b breaks to enter a short-circuit state, a DC voltage which is applied from the power source Vcc to the output terminal 13a via the resistor 20 is blocked by the other normal capacitor, and not applied to the anode of the semiconductor laser 30. Therefore, the output of the semiconductor laser 30 does not exceed the upper limit of 0.78 mW.

The first embodiment can attain the following effects.

The AC-coupling capacitor which AC-couples the output terminal 13a for the modulating current and the anode of the semiconductor laser 30 is configured by the two capacitors 90a, 90b. Even when a short-circuit state occurs in one of the capacitors, the AC-coupling is maintained by the other capacitor, and hence the output of the semiconductor laser 30 can be prevented from being excessively increased. Therefore, the safety standard of “Class 1” can be maintained.

The safety of the laser output can be ensured without impairing the characteristics of an impedance-controlled circuit board.

It is required only to change the number of AC-coupling capacitors to be mounted. Therefore, the embodiment can be easily applied to an existing laser driving circuit.

It is not necessary to mount an expensive interlock mechanism, and the circuit configuration is not complicated. Therefore, an economical circuit configuration can be realized.

As AC-coupling elements, the two AC-coupling capacitors 90a, 90b are used. Alternatively, three or more capacitors may be used.

### Second Embodiment

In a second embodiment of the invention, the semiconductor laser is arranged so that the anode of the semiconductor laser is connected to the power source Vcc, the cathode is connected to a current source to ensure a bias current, and a modulating signal from a differential pair of transistors is supplied to the cathode via plural AC-coupling capacitors which are connected together in series. Also in the embodiment, even when one of the AC-coupling capacitors is short-circuited, an excessive current can be prevented from flowing through the current source.

### Third Embodiment

A third embodiment of the invention is formed by adding an interlock mechanism to the first and second embodiments. The interlock mechanism is configured in the following manner. A switch or the like is added to a connector (not shown) through which the semiconductor laser 30 is connected to an optical waveguide such as a 25 fiber optics. When the connector is disengaged from the optical waveguide, the switch detects the disengaged state, and the laser output is interrupted or the operation of the semiconductor laser 30 is halted, whereby the optical output can be prevented from leaking to the outside.

According to the third embodiment, even when the two AC-coupling capacitors 90a, 90b enter a short-circuit state and a DC voltage is applied from the output terminal 13a to the anode of the semiconductor laser 30, the output of the semiconductor laser 30 can be prevented from being excessively increased. Therefore, the safety of the laser output can be enhanced.

### Other Embodiments

The invention is not restricted to the embodiments, and can be variously modified without departing or changing the technical concept of the invention. For example, the light emitting element is not limited to a semiconductor laser, and may be an LED and the like.

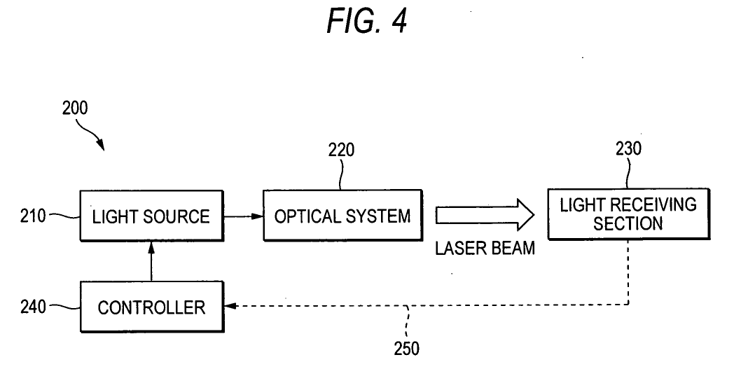

FIG. 4 shows a block diagram showing an optical transmission system. The optical transmission system 600 includes: a light source 210 having a VCSEL chip; an optical system 220 for focusing a laser beam emitted from the light source 210; a light receiving section 230 for receiving the laser beam outputted from the optical system 220; and a controller 240 for controlling a driving of the light source 210. The controller 240 includes the light emitting element driving circuit. The controller 240 supplies a driving pulse signal which drives the VCSEL to the light source 210. The light emitted from the light source 210 is transmitted to the light receiving section 230 by a fiber optics or a reflecting mirror and so on, through the optical system 220. The light receiving section 230 detects the light by a semiconductor light receiving element such as a photodetector, and controls a operation of the controller 240 (for example, a timing of an optical transmission's beginning) by a controlling signal 250.

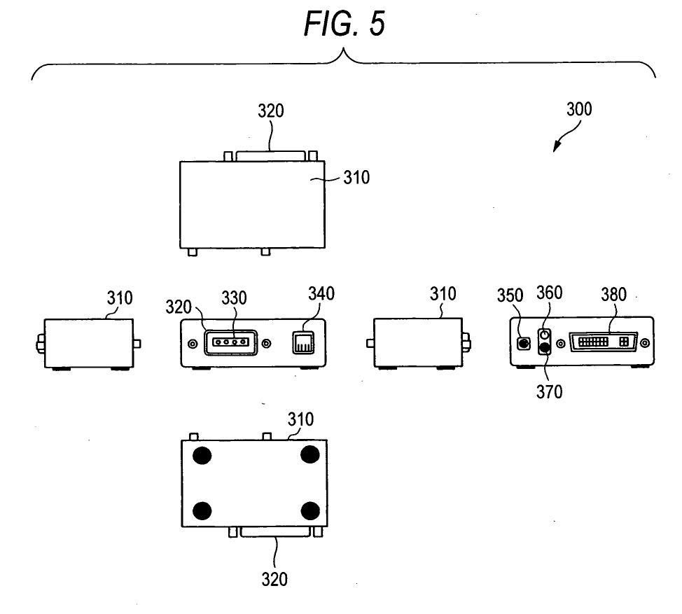

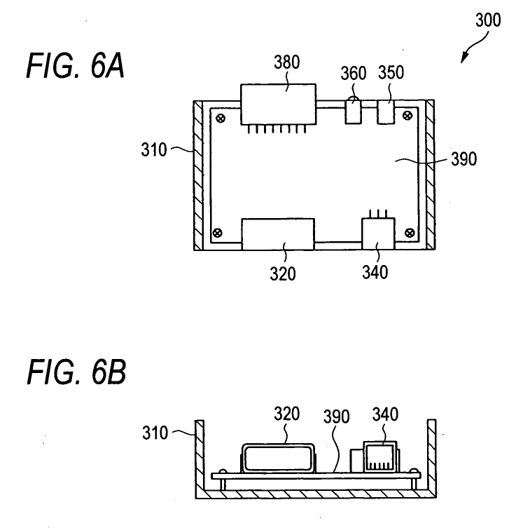

Next, an optical transmission apparatus which is used in the optical transmission system is explained below. FIG. 5 shows an external view of the optical transmission apparatus. FIGS. 6A and 6B shows internal views of the optical transmission apparatus. The optical transmission apparatus 300 includes: a case 310; a joint of an optical transmitting/receiving connecter 320; a light emitting/receiving element 330; a joint of a electronic signal cable 340; a power input part 350; a LED which shows a time of an operation 360; a LED which shows an occurrence of a malfunction 370; a DVI connector 380; and a transmitting/receiving circuit board 390. The light emitting element driving circuit is provided between the DVI connector 380 and the light emitting element 330 in a transmitting module, and enters a High/Low signal to an laser driving IC (not shown) based on a difference input signal from the DVI connector. A light quantity of the light emitting element which shows a High/Low signal is changed by the laser driving IC, and the light emitting element transmits a DVI signal as the High/Low signal to a receiving module. The light emitting element driving circuit that is provided between the laser driving IC and the light emitting element drives the light emitting element by superposing a modulating current to a bias current via the plural AC-coupling capacitors.

Generally, in a circuit for driving a vertical-cavity surface-emitting laser (VCSEL), when a modulating signal output of a laser driving IC is connected to an anode-electrode of a light emitting element via a coupling capacitor, only one coupling capacitor is implemented. When considering the safety of a laser driving circuit, the circuit should be composed so as not to output a excess laser, when the active device such as a condenser is short-circuited for some reason such as a trouble. However, when only one coupling capacitor is implemented between the modulating signal output of the laser driving IC and the anode-electrode of the light emitting element, and when the condenser is short-circuited, the light emitting element outputs a excess laser beyond a design value. Therefore, in the invention, at least two coupling capacitors are connected together in series. In this construction, the light emitting element sustains output as the design value, even if one of the condenser is short-circuited for some reason such as a trouble, because the coupling is maintained by the other coupling capacitor(s). As the above, since plural coupling capacitors are implemented between the modulating signal output of the laser driving IC and the anode-electrode of the light emitting element, a satisfy of the laser driving circuit is improved.

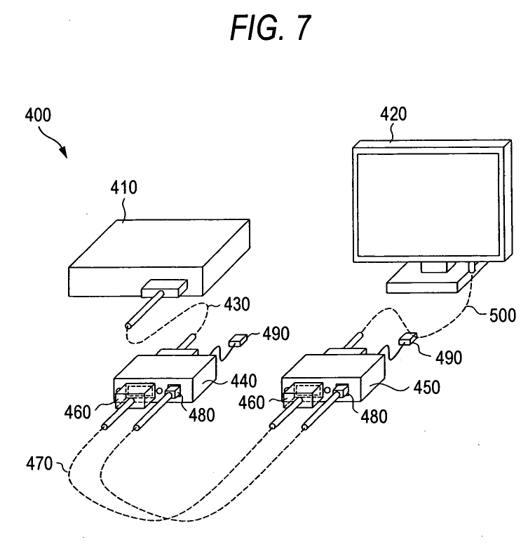

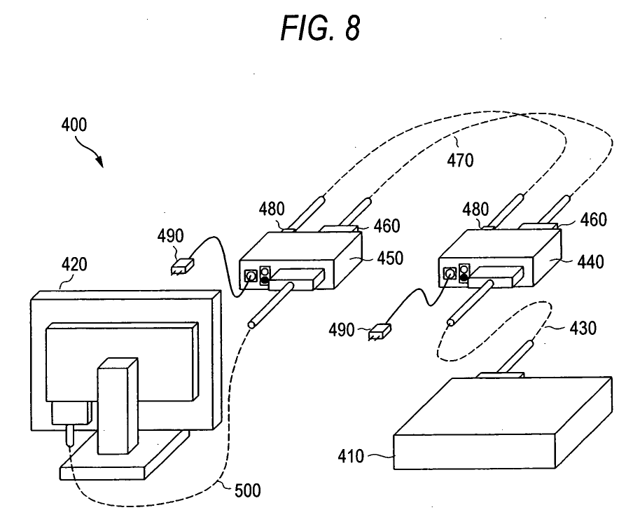

FIGS. 7 and 8 show an image transmission system using the optical transmission apparatus 300. As shown in FIGS. 7 and 8, the image transmission system 400 uses the optical transmission apparatus of FIG. 5 in order to transmit an image signal generated in an image signal generating device 410 to an image display device 420 such as a liquid crystal display. The image transmission system 400 includes: the image signal generating device 410; the image display device 420; an electric cable for DVI 430; a transmitting module 440; a receiving module 450; a connecter for an image signal transmission light signal 460; an fiber optics 470; a connector for an image signal transmission cable 480; a power adapter 490; and a electric cable for DVI 500.

In the image transmission system 400, an electric signal is transmitted between the image signal generating device 410 and the transmitting module 440, and between the receiving module 450 and the image display device 420 via the electric cables 830 or 500. The invention can be applied also to a transmission by a light signal. In this case, a electrical/optical circuit and a optical/electrical circuit can be substituted for the electric cables 830 and 500.

In the embodiments, the description has been made on an optical transmission system. The invention can be applied also to a light emitting element driving circuit used in a laser printer, a laser writing apparatus, or the like.

What is claimed is:

1. A light emitting element driving circuit comprising:
plural AC-coupling capacitors which are connected together in series; and
a bias generating circuit which generates a bias current, wherein
a light emitting element is driven by superposing a modulating current to the bias current via the plural AC-coupling capacitors.

2. The light emitting element driving circuit according to claim 1, wherein
the light emitting element is a semiconductor laser.

3. The light emitting element driving circuit according to claim 1, wherein
the light emitting element is a vertical-cavity surface-emitting laser.

4. The light emitting element driving circuit according to claim 2, wherein
the plural AC-coupling capacitors are connected between an output terminal for the modulating current and an anode of the semiconductor laser.

5. An optical transmission apparatus comprising:
a light emitting element driving circuit including plural AC-coupling capacitors which are connected together in series; and
a light emitting element for emitting aoptical signal, wherein:
the light emitting element driving circuit drives the light emitting element by superposing a modulating current to a bias current via the plural AC-coupling capacitors; and
the optical signal emitted from the light emitting element which is driven by the light emitting element driving circuit transmits information.

6. The optical transmission apparatus according to claim 5, wherein
the light emitting element is a vertical-cavity surface-emitting laser.

7. An optical transmission system comprising:
a light source for emitting a laser beam,;
an optical system for focusing the laser beam emitted from the light source;
a light receiving section for receiving the laser beam outputted from the optical system; and
a controller for controlling a driving of the light source, having
a light emitting element driving circuit including plural AC-coupling capacitors which are connected together in series, wherein:
the light emitting element driving circuit drives the light emitting element by superposing a modulating current to a bias current via the plural AC-coupling capacitors; and
the laser beam emitted from the light emitting element which is driven by the light emitting element driving circuit transmits information.

8. The optical transmission system according to claim 7, wherein
the light emitting element is a vertical-cavity surface-emitting laser.
